(19) United States
(12) Patent Application Publication
(10) Pub. No.: US 2017/0193070 A1
(43) Pub. Date: Jul. 6, 2017

(54) SYSTEM AND METHOD FOR A DISTRIBUTED REPLICATION LOCK FOR ACTIVE-ACTIVE GEO-REDUNDANT SYSTEMS

(71) Applicant: Synchronoss Technologies, Inc., Bridgewater, NJ (US)

(72) Inventors: Scott Miller, Doylestown, PA (US); Sowmya Jonnala, Basking Ridge, NJ (US); Ken Reeser, Breinigsville, PA (US); Senthil Kumar Sakkaravel, Fremont, CA (US)

(21) Appl. No.: 15/388,487

(22) Filed: Dec. 22, 2016

Related U.S. Application Data
(60) Provisional application No. 62/273,708, filed on Dec. 31, 2015.

(51) Int. Cl. G06F 17/30

(52) U.S. Cl. CPC G06F 17/30575; G06F 17/30362; G06F 17/30371

(57) ABSTRACT

A computer implemented system and method for distributed replication locks. The method comprises receiving at a first data center of a plurality of data centers, a request to perform an operation on data associated with a user; creating a lock on all of the data centers in the plurality of data centers; performing the operation associated with the request on the user data; determining that the user data is replicated across all data centers of the plurality of data centers; and purging the lock when it is determined the operation is complete on all of the data centers in the plurality of data centers.

### CROSS REFERENCE TO RELATED APPLICATIONS

This application claims benefit of U.S. Provisional Application Ser. No. 62/273,708, filed Dec. 31, 2015, which are herein incorporated by reference in its entirety.

### BACKGROUND OF THE INVENTION

Field of the Invention

Embodiments of the present invention generally relate to data integrity and, more particularly, to techniques for distributed replication locks for active-active geo-redundant systems.

Description of the Related Art

Geo-redundant systems deal with storage replication such that the same data is stored in data centers in multiple distant physical locations. Geo-redundant systems provide safeguards to the data integrity in the event a data center fails or there is some event that makes the continuation of normal functions impossible. In geo-redundant systems, data is created in a first location and then asynchronously replicated to all of the other data centers at the distant locations so that the same data exists (and is backed up) in all of the locations. Typically, these data centers remain completely independent of each other, with no need to communicate with one another beyond data transfer.

A number of types of geo-redundant systems exist. In active-active geo-redundant systems, all data centers are active and able to perform operations on user data. However, data integrity must be maintained when replicating data across multiple data centers. A geo-redundant system may consist of three data centers, for example one in New York, one in Chicago, and one in Dallas. A user may wish to perform an operation, for example an operation to add a contact. The operation may be performed in the data center in New York, but then the data must be replicated across the data centers in Chicago and Dallas. However, the user may attempt to perform another operation on their data before replication is complete across all of the data centers. If this operation is allowed, the user's data would be inconsistent across the system. As such, the user's data must be locked on all data centers until the user data is replicated across all of the data centers in the system.

Therefore, there is a need for a system and method for distributed replication locks.

### SUMMARY OF THE INVENTION

A system and method for distributed replication locks for active-active geo-redundant systems is provided.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

A method for distributed replication locks is described. The method comprises receiving at a first data center of a plurality of data centers, a request to perform an operation on data associated with a user; creating a lock on all of the data centers in the plurality of data centers; performing the operation associated with the request on the user data; determining that the user data is replicated across all data centers of the plurality of data centers; and purging the lock when it is determined the operation is complete on all of the data centers in the plurality of data centers.

In another embodiment, a system for distributed replication locks is described. The system includes a distributed database management system; a distributed configuration service; a relational database management system; a plurality of lock management server nodes, wherein each lock management server node comprises: at least one processor; at least one input device; and at least one storage device storing processor-executable instructions which, when executed by the at least one processor, perform the method for distributed replication locks.

Other and further embodiments of the present invention are described below.

### BRIEF DESCRIPTION OF THE DRAWINGS

FIG. 1 is a block diagram of a system for distributed replication locks, according to one or more embodiments;

FIG. 2 depicts a flow diagram of a method for ensuring data integrity across data centers using distributed replication locks, according to one or more embodiments;

FIG. 3 depicts a flow diagram of a method for replicating a lock across data centers, according to one or more embodiments;

FIG. 4 depicts a replication marker table used for purging locks in a data center, according to one or more embodiments; and

FIG. 5 depicts a computer system that can be utilized in various embodiments of the present invention to implement the computer and/or the display, according to one or more embodiments.

While the system and method is described herein by way of example for several embodiments and illustrative drawings, those skilled in the art will recognize that the system and method for distributed replication locks is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the system and method for distributed replication locks defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION OF EMBODIMENTS

Techniques are disclosed for distributed replication locks for active-active geo-redundant systems. An active-active geo-redundant system includes multiple data centers, where each of the data centers includes multiple storage layers. When a user wishes to synchronize their data, for example after the user has added/deleted/modified a contact, a first data center receives the request to perform the operation, and acquires a lock that is unique to the user. The lock is used to prevent additional operations on the user's data until the first operation is performed and replication of the user's data across all of the other data centers in the system is complete. The lock identifies which user's data is locked and is initialized to a largest time value supported by the system. When the first data center acquires a lock for the user's data, that data center replicates the lock in all of the other data centers, thereby blocking the other data centers from performing other operations on the user's data until replication of the first operation is complete. When the first operation is complete at the first data center, the first data center updates a timestamp of the lock identifying the time when the operation was completed. Similarly, each of the data centers updates the timestamp on their lock when replication of the user data is completed at the data center.

A replication marker table is generated on startup to indicate how data is replicated across data centers. A replication marker table resides in each data center. A row exists in each of the replication marker tables for each data center. Periodically, for example, every ten seconds, each data center updates its row in the replication marker table with the current timestamp at the data center. The marker timestamp is replicated into the replication marker tables at the other data centers. Each lock timestamp is initialized to the largest time value supported by the system, and the lock timestamp is updated with the time the operation was completed. If a data center updates its replication marker table with, for example a marker timestamp of 10:40, and this marker timestamp is replicated into the other data centers at 10:42, any lock that was updated with a completion time of 10:40 or earlier can be purged. Any lock with a timestamp greater than 10:40 cannot be purged until the replication marker timestamp increases past the lock's timestamp.

Various embodiments of a system and method for distributed replication locks are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description that follow are presented in terms of algorithms or symbolic representations of operations on binary digital signals stored within a memory of a specific apparatus or special purpose computing device or platform. In the context of this particular specification, the term specific apparatus or the like includes a general-purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

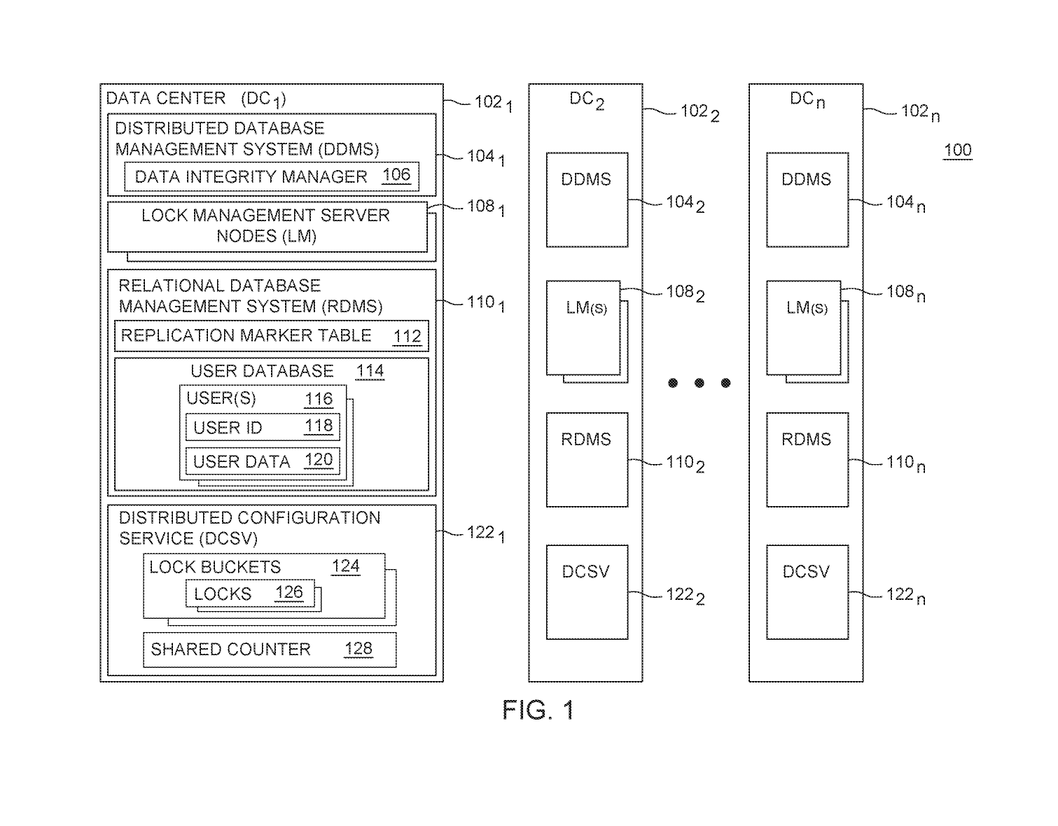

FIG. 1 is a block diagram of a geo-redundant system 100 for distributed replication locks, according to one or more embodiments. The geo-redundant system 100 includes a plurality of data centers 102₁, 102₂, . . . 102ₙ (collectively referred to herein as data center 102) communicatively coupled to one another via a network (not shown).

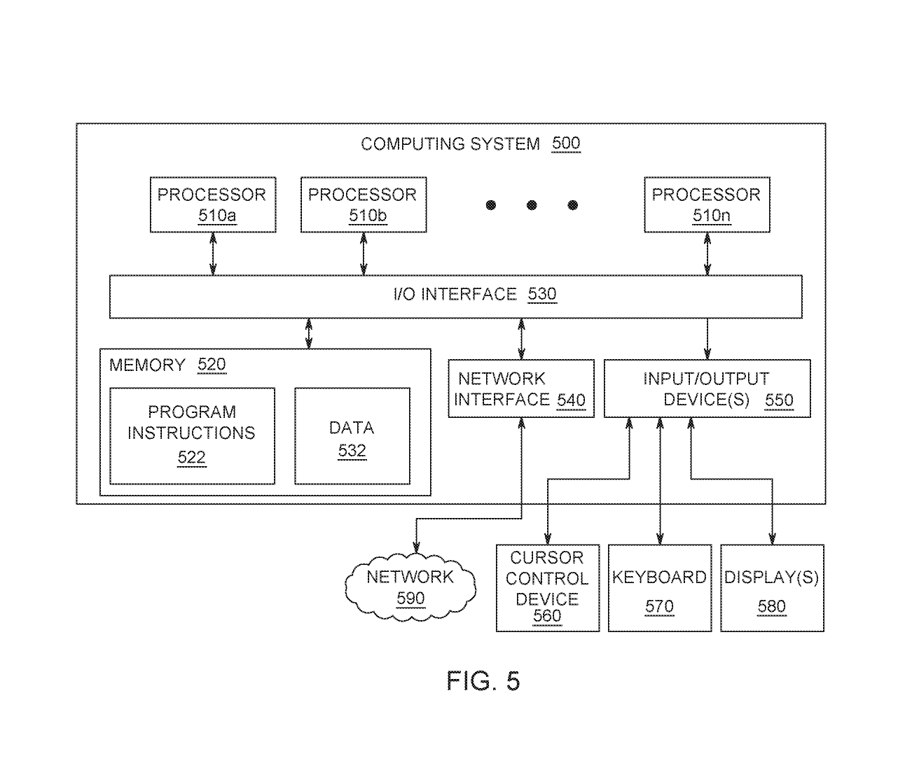

Each data center 102 is a group of networked computer servers used for the remote storage, processing and distribution of large amounts of data. Each data center 102 includes a plurality of servers including a distributed database management system 104, a plurality of lock management server nodes 108, a relational database management system 110, and a distributed configuration service 122. Each server in the data center 102 may be a computing device, for example, a desktop computer, laptop, tablet computer, and the like, or it may be a cloud based server (e.g., a blade server, virtual machine, and the like). One example of a suitable computer is shown in FIG. 5, which will be described in detail below. According to some embodiments, each server in the data center 102 includes a Central Processing Unit (CPU), support circuits, and a memory. The CPU may include one or more commercially available microprocessors or microcontrollers that facilitate data processing and storage. The various support circuits facilitate the operation of the CPU and include one or more clock circuits, power supplies, cache, input/output circuits, and the like. The memory includes at least one of Read Only Memory (ROM), Random Access Memory (RAM), disk drive storage, optical storage, removable storage and/or the like.

The distributed database management system 104 includes a data integrity manager 106. The distributed configuration service 122 includes a plurality of lock buckets 124, each of which house one or more locks 126. There is a one-to-one correspondence between lock buckets 124 and lock management server nodes 108 at a data center 102. The distributed configuration service 122 also includes a shared counter 128 used for assigning a lock bucket index to each lock management server node 108 at startup. The relational database management system 110 includes a replication marker table 112, which is used to purge locks after user data has been replicated across all data centers (i.e., data center 102₁, data center 102₂, . . . data center 102ₙ), and a user database 114 for a plurality of users 116. Each user 116 includes a user identifier (ID) 118 and user data 120.

The data centers 102 may be connected to external systems via a network (not shown), such as a Wide Area Network (WAN) or Metropolitan Area Network (MAN), which includes a communication system that connects computers (or devices) by wire, cable, fiber optic and/or wireless link facilitated by various types of well-known network elements, such as hubs, switches, routers, and the like. The network interconnecting some servers in each data center 102 may also be part of a Local Area Network (LAN) using various communications infrastructure, such as Ethernet, Wi-Fi, a personal area network (PAN), a wireless PAN, Bluetooth, Near field communication, and the like.

When the lock management server node 108 starts up, the lock management server node 108 is assigned an index for a lock bucket 124, from where the lock management server node 108 will retrieve locks. The index for the lock bucket 124 is assigned to the lock management server node 108 using a shared counter 128 to ensure that no two lock management server nodes 108 share a lock bucket 124. The lock bucket 124 identifies a physical location where the lock management server node 108 may locate a lock associated with the user.

When a lock management server node 108 receives a first request from a user device (not shown) to perform an operation, for example add a contact, the lock management server node 108 must ensure that while the user's contacts are being updated on all of the data centers 102, that no attempt is made to update the user's data with another operation. Therefore, the lock management server node 108 creates a lock 126 in its assigned lock bucket 124. The lock management server node 108 then replicates the lock 126 across all of the data centers 102. The lock 126 identifies which user's data 120 is being locked in the data center 102. The lock 126 also includes a timestamp, which is initialized to a largest time value supported by the system and which is later updated when the operation is complete. The lock management server node 108 then determines in which lock bucket 124 to replicate the lock 126 in each data center, based on a hash of the user ID 118 associated with the user data 120 and a number of lock management server nodes 108 in the given data center 102.

A second request to perform an operation on the user data 120 may be received at one of the data centers 102. The lock management server node 108 determines in which lock bucket 124 a lock would exist if an operation is already being performed, or if user data 120 is still being replicated at the data center 102. The lock bucket 124 is determined based on a hash of the user ID 118 and the number of lock management server nodes 108 at the data center 102. If a lock 126 already exists that has locked the user data 120, and the second request is received at a data center 102 that is different than the data center 102 that received the first request, then the second request is denied or delayed until the operation associated with the first request is complete. If the second request is received at the same data center 102 as the first request, then the second request is performed and the user data 120 is again replicated across the data centers 102.

The operation received in the first request is performed on the user data 120. When the operation is complete, the timestamp of the lock 126 is updated with the completion time (i.e., the time the operation associated with the first request completed.) The user data 120 is then replicated at each data center 102. When replication is complete at a data center, the data center updates the lock 126 in the lock bucket 124 with a timestamp that identifies the time the operation was completed at the data center 102. Updating the timestamp prepares the lock 126 for release.

A second process is performed in parallel to the locking of the user data 120 and updating of the timestamp upon completion. The data integrity manager 106 generates the replication marker table 112 at startup. The replication marker table 112 includes a row for each data center 102. Periodically, for example every ten seconds, the lock management server node 108 in each data center updates the row in the replication marker table 112 that is associated with the data center 102 where the lock management server node 108 is located. The lock management server node 108 that performed the operation updates the marker timestamp in the replication marker table 112 in its own data center 102. The row is updated with the current timestamp at the data center 102. The marker timestamp in the replication marker table 112 is then replicated in the replication marker table 112 across all of the other data centers. As described above, each lock 126 was initialized with the largest time value supported by the system and the lock is updated with a completion time. Periodically, the data integrity manager 106 checks its replication marker table 112. Any lock 126 that has a timestamp before the marker timestamp in the replication marker table 112 (i.e., the timestamp is before or equal to the timestamp in the replication marker table 112) may be purged from the lock bucket 124 on the data center 102. If a lock 126 has a timestamp after the marker timestamp in the replication marker table 112, then it cannot be purged. The data integrity manager 106 waits until the marker timestamp is later than the timestamp of the lock 126 before purging the lock 126 from the lock bucket 124.

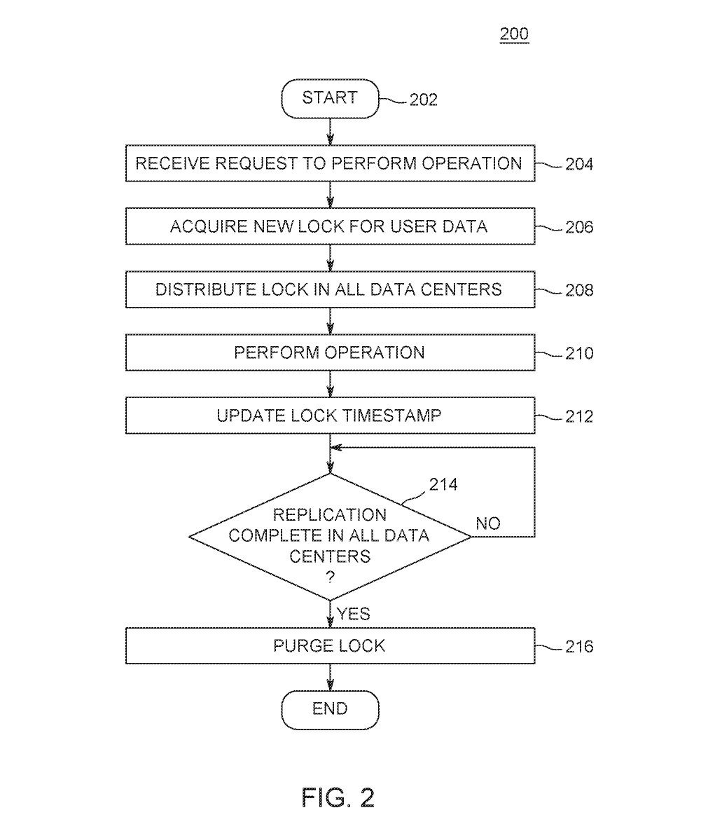

FIG. 2 depicts a flow diagram of a method 200 for ensuring data integrity across multiple data centers using distributed replication locks, according to one or more embodiments. The method 200 starts at step 202 and proceeds to step 204.

At step 204, a request is received to perform an operation. The request may be received from a user device for example, to update or synchronized data that is stored for the user by, for example a cloud storage service provider. The request is received in a first data center of a plurality of data centers in an active-active geo-redundant system.

At step 206, a new lock is acquired for the user data on which the operation is to be performed. The lock is stored in a lock bucket in a distributed configuration service location in the first data center. The lock identifies the user identifier associated with user whose data is being operated upon. The lock also identifies in what lock bucket of which data center the lock resides. For example, the lock may be stored as follows:
/globallocks/DC(N)/LB(M)/{UserID}, where
DC(N) identifies the data center;
LB(M) identifies in which lock bucket the lock resides; and
User ID identifies a unique identifier associated with the user on whose data is being operated.

In addition, the lock has a timestamp. The timestamp is initialized to a largest time value supported by the system.

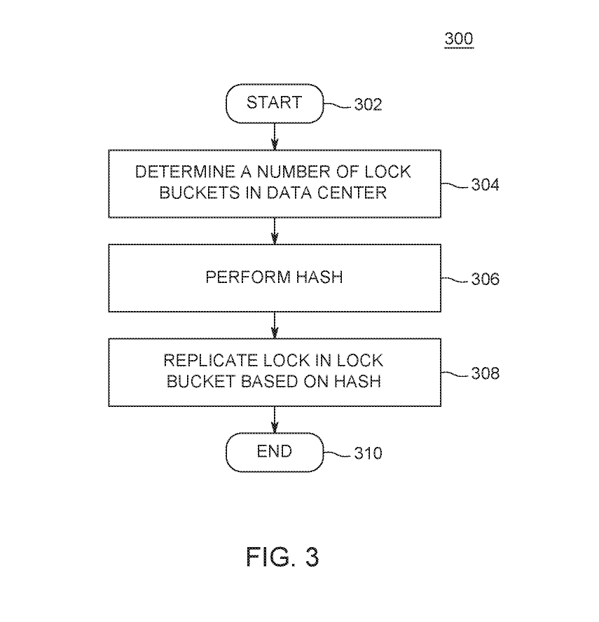

At step 208, the lock is distributed across all of the other data centers, as described in further detail with respect to FIG. 3, below.

At step 210, the requested operation is performed. The user data is then replicated in the other data centers, although each data center works independently.

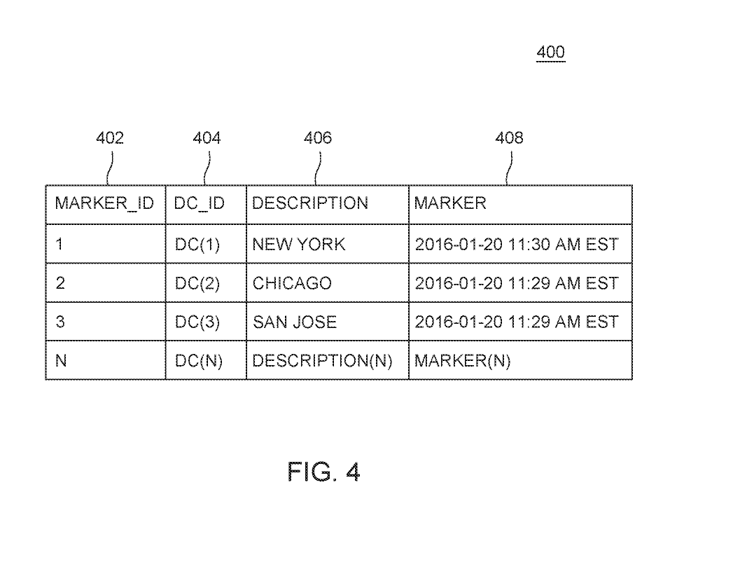

At step 212, the timestamp of the lock is updated. The updated timestamp identifies the time that the operation was completed. As such, the timestamp that was initially the largest supported time value is replaced by a current time. The timestamp of the lock indicates that the operation is complete at the data center. Periodically, for example, every ten seconds, each data center updates its marker timestamp in the replication marker table with the current time, as described in further detail with respect to FIG. 4, below.

At step 214, it is determined whether the operation is complete across all of the data centers. The replication marker table is accessed. If the timestamps of the locks from the data center are in the past (i.e., less than or equal to the marker timestamp in the replication marker table), then the user's data in the data center is in sync and the method 200 proceeds to step 216, where the locks are purged from the lock buckets. However, if one or more timestamps of the locks are in the future, then the one or more data centers have not completed the operation and the user data in the data centers is not in sync. If it is determined that the data centers are not yet in sync, then the method 200 waits a predefined period of time and returns to step 214 to recheck the lock timestamps against the marker timestamps. When it is determined that the lock timestamps are all in the past and the user data is synchronized across all data centers, then at step 216, the lock is purged from the lock bucket. The same operation is performed at each data center to purge the locks.

The method 200 proceeds to step 220 and ends.

FIG. 3 depicts a flow diagram of a method 300 for replicating a lock across data centers, according to one or more embodiments. The lock was created by a first data center (i.e., the data center where a request to perform an operation was received.) The method 300 is performed by the lock management node in the first data center and is performed for each data center. The method 300 starts at step 302 and proceeds to step 304.

At step 304, a number of lock buckets is determined on a remote data center.

At step 306, the lock bucket where the lock is to be stored is determined. A user ID is identified for the user whose data is being updated. A hash value for the user ID is calculated using any hash function known in the art. The lock bucket in which the lock is to be stored is calculated using, for example the following formula:

LB=Hash (User ID) mod LB(N), where

LB(N) is the number of lock buckets determined in step 304.

At step 308, the lock is stored in the determined lock bucket and the method 300 ends at step 310.

FIG. 4 depicts a replication marker table 400 used for purging locks in a data center, according to one or more embodiments. The replication marker table 400 is generated upon startup. A replication marker table 400 is generated in each of the data centers. The replication marker table 400 includes a marker identifier 402, a data center identifier (DC_ID) 404, description 406, and a marker timestamp 408. Prior to performing the operation, a lock is stored in a lock bucket on each data center. The lock includes a timestamp, which is initialized to a largest supported time value, and only updated when the operation is complete or the data is replicated in the data center.

Periodically, for example, every ten seconds, each data center updates the marker timestamp 408 in its row associated with the data center and the timestamp is replicated in each replication marker table 400 across the system. The replication marker table 400 is updated by a background process running at the data center. The marker timestamp 408 is the time the replication table was last updated with the current time by the background process. Each time the marker timestamp 408 is updated, the marker timestamp 408 is replicated across all data centers. When the operation (or replication of data) is complete at a data center, the lock timestamp is updated. Yet another background process periodically checks the marker timestamps 408 in the replication marker table 400 located on the data center. Any locks at the data center that have a timestamp that is less than or equal to the marker timestamp may be purged. However, if there are any locks at the data center that have a timestamp that is later than the marker timestamp, the lock cannot be purged. Only when the timestamp of the lock is past the marker timestamp, can it be purged and removed from the lock bucket at the data center.

FIG. 5 depicts a computer system 500 that can be utilized in various embodiments of the present invention to implement the computer and/or the display, according to one or more embodiments.

Various embodiments of system and method for distributed replication locks, as described herein, may be executed on one or more computer systems, which may interact with various other devices. One such computer system is computer system 500 illustrated by FIG. 5, which may in various embodiments implement any of the elements or functionality illustrated in FIGS. 1-4. In various embodiments, computer system 500 may be configured to implement methods described above. The computer system 500 may be used to implement any other system, device, element, functionality or method of the above-described embodiments, or example the distributed database management system 104, lock management server nodes 108, distributed configuration service 122, and relational database management system 110. In the illustrated embodiments, computer system 500 may be configured to implement the methods 200 and 300 as processor-executable executable program instructions 522 (e.g., program instructions executable by processor(s) 510) in various embodiments.

In the illustrated embodiment, computer system 500 includes one or more processors 510a-510n coupled to a system memory 520 via an input/output (I/O) interface 530. Computer system 500 further includes a network interface 540 coupled to I/O interface 530, and one or more input/output devices 550, such as cursor control device 560, keyboard 570, and display(s) 580. In various embodiments, any of the components may be utilized by the system to receive user input described above. In various embodiments, a user interface may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In different embodiments, computer system 500 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 500 may be a uniprocessor system including one processor 510, or a multiprocessor system including several processors 510 (e.g., two, four, eight, or another suitable number). Processors 510 may be any suitable processor capable of executing instructions. For example, in various embodiments processors 510 may be general-purpose or embedded processors implementing any of a variety of instruction set architectures (ISAs). In multiprocessor systems, each of processors 510 may commonly, but not necessarily, implement the same ISA.

System memory 520 may be configured to store program instructions 522 and/or data 532 accessible by processor 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500.

In one embodiment, I/O interface 530 may be configured to coordinate I/O traffic between processor 510, system memory 520, and any peripheral devices in the device, including network interface 540 or other peripheral interfaces, such as input/output devices 550. In some embodiments, I/O interface 530 may perform any necessary protocol, timing or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network (e.g., network 590), such as one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 550 may, in some embodiments, include one or more display terminals, keyboards, keypads, touchpads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

In some embodiments, the illustrated computer system may implement any of the operations and methods described above, such as the operations described with respect to FIG. 2, FIG. 3, and FIG. 4. In other embodiments, different elements and data may be included.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined.

1. A computer implemented method for distributed replication locks comprising:
receiving at a first data center of a plurality of data centers, a request to perform an operation on data associated with a user;
creating a lock on all of the data centers in the plurality of data centers;
performing the operation associated with the request on the user data;
determining that the user data is replicated across all data centers of the plurality of data centers; and
purging the lock when it is determined the operation is complete and the user data is replicated across all of the data centers in the plurality of data centers.

2. The method of claim 1, wherein each of the plurality of data centers comprises a plurality of lock management server nodes and a configuration service comprising a plurality of lock buckets.

3. The method of claim 2, wherein there is a one-to-one correspondence between lock management server nodes and lock buckets.

4. The method of claim 2, wherein a lock bucket is assigned to a lock management node at startup using a shared counter mechanism.

5. The method of claim 1, wherein the lock is unique to the user and wherein the lock is held on the data associated with the user until the operation on the user data is complete and the user data has been replicated across the plurality of data centers.

6. The method of claim 1, wherein the lock is assigned to a lock bucket using a formula: hash(user ID) mode LB(N), wherein the user ID is a unique identifier associated with the user whose data is being locked and wherein N is a number of lock buckets in the data center.

7. The method of claim 6, wherein purging the lock comprises deleting the lock associated with the operation from the lock bucket.

8. The method of claim 6, wherein creating a lock comprises:
identifying a user identifier associated with a user whose data is being operated upon;
determining a lock bucket in which to store the lock; and
initializing a timestamp to the lock, wherein a timestamp of the lock is initialized to a largest supported time value.

9. The method of claim 8, further comprising updating the timestamp of the lock when the operation is complete, wherein the timestamp is updated to a time the operation is complete.

10. The method of claim 1, wherein determining the operation is complete across all data centers in the plurality of data centers comprises:
accessing a replication marker table, wherein the replication marker table comprises a row for each data center in the plurality of data centers and each row comprises a marker timestamp that identifies a last updated time in each data center of the plurality of data centers; and
determining that a timestamp associated with the lock in each data center is less than or equal to the marker timestamp.

11. A system for distributed replication locks comprising a plurality of data centers wherein each of the plurality of data centers comprises:
a distributed database management system;
a distributed configuration service;
a relational database management system;
a plurality of lock management server nodes, wherein each lock management server node comprises:
a) at least one processor;
b) at least one input device; and
c) at least one storage device storing processor-executable instructions which, when executed by the at least one processor, perform a method including:
receiving at a first data center of a plurality of data centers, a request to perform an operation on data associated with a user;
creating a lock on all of the data centers in the plurality of data centers;
performing the operation associated with the request;
determining that the user data is replicated across all data centers of the plurality of data centers; and
purging the lock when it is determined the operation is complete and the user data is replicated across all of the data centers in the plurality of data centers.

12. The system of claim 11, wherein the distributed configuration service comprises a plurality of lock buckets.

13. The system of claim 12, wherein there is a one-to-one correspondence between lock management server nodes and lock buckets.

14. The system of claim 12, wherein a lock bucket is assigned to a lock management node at startup using a shared counter mechanism.

15. The system of claim 11, wherein the lock is unique to the user and wherein the lock is held on the data associated with the user until the operation on the user data is complete and the user data has been replicated across the plurality of data centers.

16. The system of claim 11, wherein the lock is assigned to a lock bucket using a formula: hash(user ID) mode LB(N), wherein the user ID is a unique identifier associated with the user whose data is being locked and wherein N is a number of lock buckets in the data center.

17. The system of claim 16, wherein purging the lock comprises deleting the lock associated with the operation from the lock bucket.

18. The system of claim 16, wherein creating a lock comprises:
identifying a user identifier associated with a user whose data is being operated upon;
determining a lock bucket in which to store the lock; and
initializing a timestamp to the lock, wherein a timestamp of the lock is initialized to a largest supported time value.

19. The system of claim 18, further comprising updating the timestamp of the lock when the operation is complete, wherein the timestamp is updated to a time the operation is complete.

20. The system of claim 11, wherein determining the user data is replicated across all data centers in the plurality of data centers comprises:
accessing a replication marker table, wherein the replication marker table comprises a row for each data center in the plurality of data centers and each row comprises a marker timestamp that identifies a last update time in each data center of the plurality of data centers; and
determining that the timestamp associated with the lock in each data center is less than or equal to the marker timestamp.
